(19) United States
(12) Patent Application Publication
(10) Pub. No.: US 2007/0208809 A1
(43) Pub. Date: Sep. 6, 2007

(54) GROUP INVITATION

(76) Inventor: ILKKA WESTMAN, HELSINKI (FI)

Correspondence Address: Hollingsworth & Funk, 8009 34th Avenue South, Suite 125, Minneapolis, MN, 55425, US

(21) Appl. No.: 11/578,923

(22) PCT Filed: Apr. 25, 2005
(86) PCT No.: PCT/FI05/50132

§ 371 Date: Oct. 19, 2006

(30) Foreign Application Priority Data
Apr. 23, 2004 (FI) 20040576
Apr. 27, 2004 (FI) 20040594

(51) Int. Cl. G06F 15/16

(52) U.S. Cl. 709/205

(57) ABSTRACT

In a system providing a group communication service and supporting groups containing other groups as group members, the group members not hosted by a server hosting the group are invited to join to the group by sending an invitation to join the group to a server hosting the group member.

### FIELD OF THE INVENTION

The present invention relates to group communication in communications systems providing a group communication service, and more particularly to group invitations during a session set-up or to group transactions when group definition allows nested groups.

### BACKGROUND OF THE INVENTION

One special feature offered in mobile communications systems is group communication. The term “group”, as used herein, refers to any logical group of two or more users intended to participate in the same group communication. One example of group communication is a group call, which is a call in which all participants may take turns to speak and to listen to each other.

Conventionally group communication has been available only in trunked mobile communications systems, such as Professional Mobile Radio or Private Mobile Radio (PMR) systems, such as TETRA (Terrestrial Trunked Radio), which are special radio systems primarily intended for professional and governmental users. However, since group communication opens up more versatile possibilities than a conference call, the group communication service is also now becoming available in public mobile communications systems. An example of such a service is Push-to-talk over Cellular (PoC), which allows user voice and data communications shared with a single recipient (one-to-one) or between groups of recipients as in a group chat session (one-to-many) over mobile networks.

PoC is an overlay speech service in a mobile cellular network where a connection between two or more parties is typically established for a long period but the actual radio channels in the air interface are activated only when someone is talking or sending data. This corresponds to the usage of traditional radiotelephones where the used radio frequency is agreed between the parties (e.g. military/police radios, LA radios) or permanently set (walkie-talkie type of radios) and whenever someone wants to talk, she/he presses the tangent or uses a voice activity detector (VAD) or any suitable means, which activates the radio transmission on the selected channel. The PoC service is half-duplex so that only one party can talk or send at a time.

The PoC systems are evolving from standalone PoC systems to integrated systems. In an integrated system with two or more separately operated PoC systems and/or PoC servers, the existing home PoC servers only manage information on their own users and on groups they host. This introduces some difficulties since a group list may contain as a group member another group, for example a group member list of a group A may contain a group B. If the groups A and B are hosted by different PoC servers, the PoC server hosting the group A cannot know whether the identity B is an individual user, i.e. an individual identity, or a group, i.e. a group identity. Since the system can only use individual identities when inviting individual group members to join the group session, this information is vital. An invitation sent to the group identity B will not succeed and no group member of that group will be invited to join the group session.

One solution is to retrieve, before starting to set up the session, the members in the group member list(s) by sending a query to an entity that stores the member list of the group in question, such as another PoC server or a Group and List Management Server (GLMS), which returns the individual group members. This query has to be sent for every single identity not hosted by the PoC server in the group member list of the group A in order to ascertain that invitations to join the group are sent to individual users. Thus, it delays the starting of the session set-up. Furthermore, since member lists of groups may be maintained in another PoC server or GLMS serving the hosting PoC server of the group in question, the PoC server hosting the group A has to send a query also to GLMS containing the member list of group B or to the other PoC. The same also applies to individual identities hosted by other PoC servers. This requires a new interface for sending a query to GLMSs not serving the inquiring PoC server. A new interface is also required to send queries to other PoC servers containing a member list(s) of a group(s).

### BRIEF DESCRIPTION OF THE INVENTION

An object of the present invention is to provide a method and an apparatus for implementing the method so as to overcome the above problems. The object of the invention is achieved by methods, user equipment and group communication servers which are characterized by what is stated in the independent claims. The preferred embodiments of the invention are disclosed in the dependent claims.

One aspect of the invention is based on the idea of utilizing the fact that the group communication server, i.e. the PoC server, hosting an identity knows whether the identity is an individual identity or a group identity. This fact is used to solve the group identities during the session set-up procedure, not in advance, by arranging the PoC servers to send invitations intended for identities not hosted by that specific PoC server to a PoC server hosting that identity, paying no attention to whether or not the identities are group identities. Since each PoC server recognizes the groups it is hosting, according to the invention each PoC server either in turn invites the members of the hosted group or gathers the group member list which is then used to invite individual group members to join the group communication.

An advantage of the above aspect of the invention is that no additional interfaces are needed between GLMSs over a network boundary, i.e. between different GLMSs located in different networks or between a PoC server sending a query to GLMS or to another PoC server over a network boundary. Furthermore, the session set-up can be started without delay, since group identities among the identities to be invited do not delay the invitation of other group members and, yet, the invitations are eventually sent to individual identities.

### BRIEF DESCRIPTION OF THE DRAWINGS

In the following the invention will be described in greater detail by means of preferred embodiments with reference to the accompanying drawings, in which FIG. 1 illustrates an example of the general architecture of a communications system providing group communication service;

FIG. 2 illustrates different controlling functions according to a first embodiment of the invention;

FIG. 3 is a flow chart illustrating a functionality of a PoC server according to the first embodiment of the invention;

FIGS. 4 and 5 are signaling diagrams illustrating signaling according to the first embodiment of the invention;

FIG. 6 is a flow chart illustrating functionality of a PoC server according to a second embodiment of the invention;

FIG. 7 is a signaling diagram illustrating signaling according to the second embodiment of the invention;

FIG. 8 is a flow chart illustrating a third embodiment of the invention; and

FIG. 9 is a flow chart illustrating a functionality of a PoC server.

### DETAILED DESCRIPTION OF THE INVENTION

The present invention is applicable to any communications system providing a group communication service. Group communication, as used herein, refers to a multipoint communication relationship between members in a group for the purpose of transferring data. The communication may include data calls, audio calls, video calls, multimedia calls, group messaging, short messaging, electronic mail, instant messaging, etc. Thus, the communication includes all existing or future media or the like and any combination of these. Members in the group are defined with special group communication information that associates a specific user with the particular group.

In the following, the present invention is described using, as an example of a system environment where the present invention may be employed, a mobile communication system with PoC without restricting the invention to such a system, however. A PoC industry specification is currently being developed by a PoC working group under the OMA (Open Mobile Alliance). Originally the PoC specification was prepared by a group of organizations with the aim of following the existing 3^{rd} Generation Partnership Project (3GPP) IP Multimedia Subsystem (IMS) specifications. More detailed information on PoC can be found via the Internet pages www.openmobilealliance.org.

For a person skilled in the art, it is clear that the invention is also applicable to other types of telecommunication systems capable of providing a group communication service, for example to the TETRA, conferencing, instant messaging to a group, message session to a group, RLS (Resource List Server), push services to groups, or any service addressing to identity/identities that may be a group or may be expanded to a group, or any similar application or the like. Furthermore, it is clear for a person skilled in the art that the invention is not limited to certain media type but the invention can be applied independently of the media, media type, media parameters and other characteristics of the media, and that the invention described herein may in addition to, or instead of PoC be used with other functions, servers, services, systems, networks or the like. The specifications of communications systems and particularly wireless communications systems providing a group communication service develop rapidly. This development may require extra changes to the invention. Therefore, all terms and expressions should be interpreted broadly, and they are intended to illustrate, not restrict the invention. Furthermore, the elements in which the inventive functions are performed is(are) not essential to the invention.

The general architecture of a communications system providing a group communication service according to PoC is illustrated in FIG. 1. FIG. 1 is a simplified system architecture only showing some elements. The network nodes shown in FIG. 1 are logical units whose implementation may differ from what is shown. The logical units may be combined with each other, i.e. a functionality of one logical unit described below may be enhanced to comprise a functionality of another logical unit described below and/or a functionality of a prior-art network node (logical unit). The connections shown in FIG. 1 between network nodes are logical connections; the actual physical connections may be different than the logical connections. It is apparent to a person skilled in the art that the systems also comprise other functions and structures that need not be described in detail herein. The implementation of the devices and the system entities providing the group communication service, such as servers and/or server components in a network, may vary according to the specific communications system which the present invention is applied to and according to the embodiment used.

The network elements illustrated in FIG. 1 are a home network 1-1 comprising a PoC client 1-11, an access network 1-12, a core network 1-13, GLMS 1-14 and a PoC server 1-15, and remote networks 1-2 having PoC servers 1-25 (only one remote network with a PoC server is illustrated in FIG. 1). The remote networks preferably contain similar network elements and functions as the home network. GLMS covers here all corresponding servers, such as XDMS (XML Document Management Server) and Group Management Server.

The PoC client 1-11 is used to access the PoC service. The PoC client 1-11 allows, among other things, PoC session initiations and provides access to different PoC group lists, such as contact lists. The PoC client 1-11 resides in user equipment. Examples of user equipment in which the PoC client may reside are a mobile terminal, personal computer and any device containing a computer or the like. The PoC client or the user equipment in which the PoC client resides may be configured to add to a group communication invitation a limit value for nested groups described in more detail later. The limit value may be added to the invitation in response to a user giving it, or it may be stored as a general default value, or as a group-specific value, for example.

In PoC, the group communication service functionality is a user or application level service so that the underlying communications system only provides the basic connections (i.e. IP connections) between the PoC client applications residing in user terminals and the group communication service functionality provided by a PoC server. The underlying communications system comprises the access network 1-12 and the core network 1-13. The access network 1-12 used by the PoC architecture includes both radio access and the other nodes required to gain IP connectivity and IP mobility. However, the access network is not limited to IP networks but the access network may be WLAN, PSTN, GSM, or any circuit-switched or IP-based network or any similar network or the like. The core network 1-13 is a SIP/IP (session initiation protocol/internet protocol) network. Examples of such a network are an IMS network and a SIP/IP network having similar capabilities as defined for the IMS, such as an AII-IP system standardized by the 3GPP or 3GPP2 or IETF and supporting of an IP-based session control protocol. The SIP/IP core network 1-13 includes a number of SIP proxies and SIP registrars, and performs functions needed in support of the PoC, such as routing the SIP signaling between the PoC client 1-11 and the PoC server 1-15. However, as stated above, the core network is not limited to the SIP/IP networks but it may be any communications network providing the same service utilizing protocol(s) with which the present invention can be implemented.

The subscriber and group management function, or the part of it needed for the PoC service is implemented in a Group and List Management Server GLMS 1-14. It or a part of it may be implemented on the PoC server 1-15. GLMS provides storage for groups and lists and list management operations to create, modify, retrieve, and delete groups and lists to a PoC client 1-11 in the same home network. Group information in PoC is structured into groups, contact lists, and access lists. Contact lists are used for storing contact entries in GLMS 1-14, and they act as address books for the PoC users in establishing an instant talk session with other PoC users or PoC groups. A PoC user may have one or more contact lists, and each contact list is uniquely identified by its SIP URI (uniform resource identifier). The SIP URI is used within a SIP message to indicate the originator, current destination, and final recipient of an SIP request, and to specify redirection addresses. Usually an SIP URI is in the form of user@host. The PoC user stores user contacts in lists of the type “user” and group contacts to lists of the type “group”. However, the details of the groups and lists management are irrelevant for the present invention.

Detailed technical specifications for the system elements described above, their implementation and functionality are irrelevant for the present invention and need not to be discussed in more detail herein. Furthermore, they are considered well known to a person skilled in the art since they are publicly available in different specifications, such as the 3GPP specifications, the OMA specifications, and the IETF specifications.

The PoC server 1-15 implements the application-level network functionality for the PoC. In other words, the PoC Server 1-15 represents a media communications server that is the end-point of the SIP, a transport protocol, and a transport control protocol, such as Real-time Transport protocol (RTP) and Real-time Transport Control Protocol (RTCP) signaling. The functionality of a PoC server according to the invention depends on the used embodiment and is described in detail below. The PoC server represents herein a server implementing a group communication functionality. The group communication functionality, i.e. a PoC server, according to the invention contains at least one of the functionalities described below as a PoC server-specific functionality. The group communication functionality may contain more than one of them, it may even contain all of them. For clarity's sake, the term “PoC server” is used below to cover all servers implementing a group communication functionality.

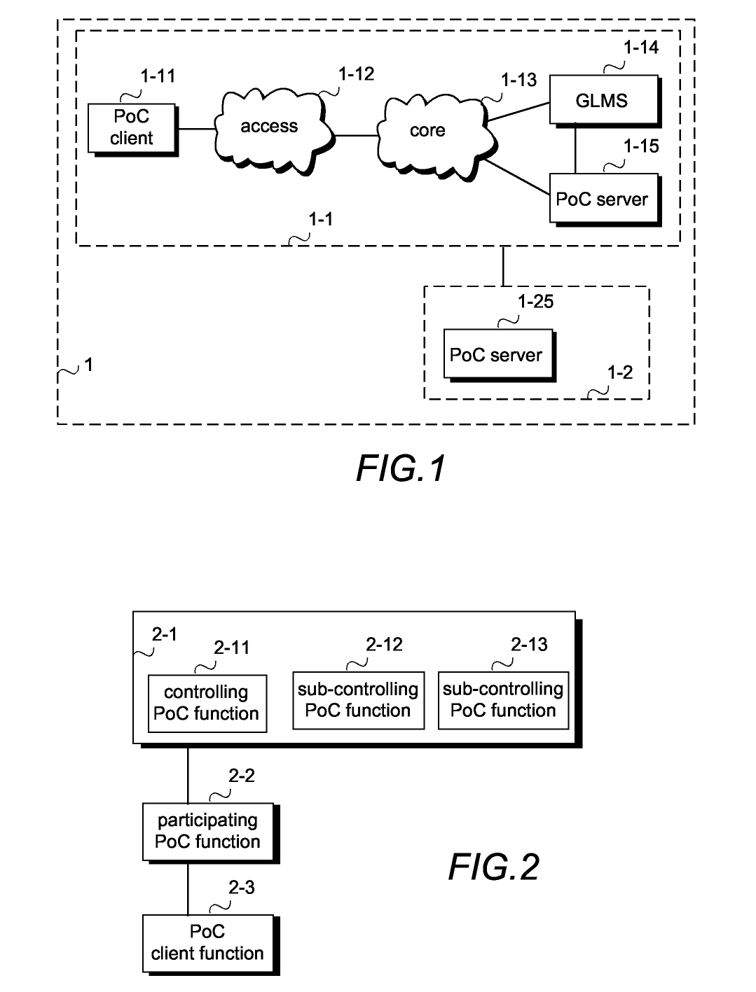

FIG. 2 illustrates a functional PoC architecture according to a first embodiment of the invention. The PoC server may perform a controlling PoC function 2-1 and/or a participating PoC function 2-2. In a PoC group session, there is only one PoC server performing the controlling PoC function but there can be one or more PoC servers performing the participating PoC function. The controlling PoC function and participating PoC function are different roles of the PoC server. The determination of the PoC server role (controlling PoC function or participating PoC function or both) takes place during the PoC group session set up and lasts for the duration of the whole PoC group session. In case of an one-one PoC group session and an ad-hoc PoC group session, the PoC server of the inviting user shall perform the controlling PoC function. In case of a chat PoC group and a pre-arranged group session the PoC server owning/hosting the group identity shall perform the controlling PoC function.

Furthermore, according to the first embodiment of the invention, as shown in FIG. 2, there are two kinds of controlling PoC functions: a main controlling PoC function 2-11 and a sub-controlling function 2-12, 2-13. Thus, the first embodiment can be seen as a distributed control solution. The PoC server performing the main controlling PoC function refers to the PoC server performing the controlling PoC function discussed above, and thus there can only be one main controlling PoC function for a PoC group session. However, there can be zero or more sub-controlling functions for the same PoC group session since the sub-controlling PoC function is not a main controlling PoC function. A sub-controlling PoC function and a participating PoC function can also reside in one PoC server, even together with the main controlling PoC function. It is also possible that one or more sub-controlling PoC functions reside in the same PoC server with the main controlling PoC function, although the participating PoC function(s) do not reside there.

The main controlling PoC function, or, in embodiments not supporting the sub-controlling PoC function, the controlling PoC function provides centralized PoC session handling, media distribution, floor control functionality including talker identification, SIP session handling, policy enforcement for participation in group sessions, the participants' information, charging reports, and both collects and provides centralized media quality information. Thus, the (main) controlling PoC function may receive talk burst reservation requests from identities it hosts as well as from sub-controlling PoC functions, it grants the right to start a talk burst to the identities it hosts and to identities hosted by a sub-controlling PoC function (possibly via one or more sub-controlling PoC functions). Below, the main controlling PoC function is called controlling PoC function for simplicity's sake.

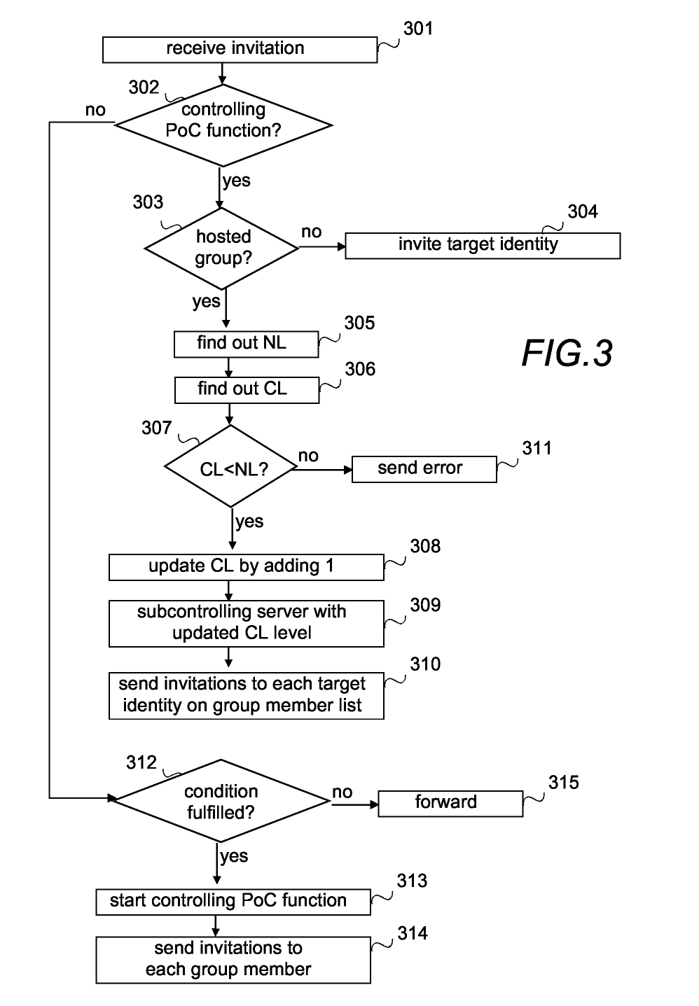

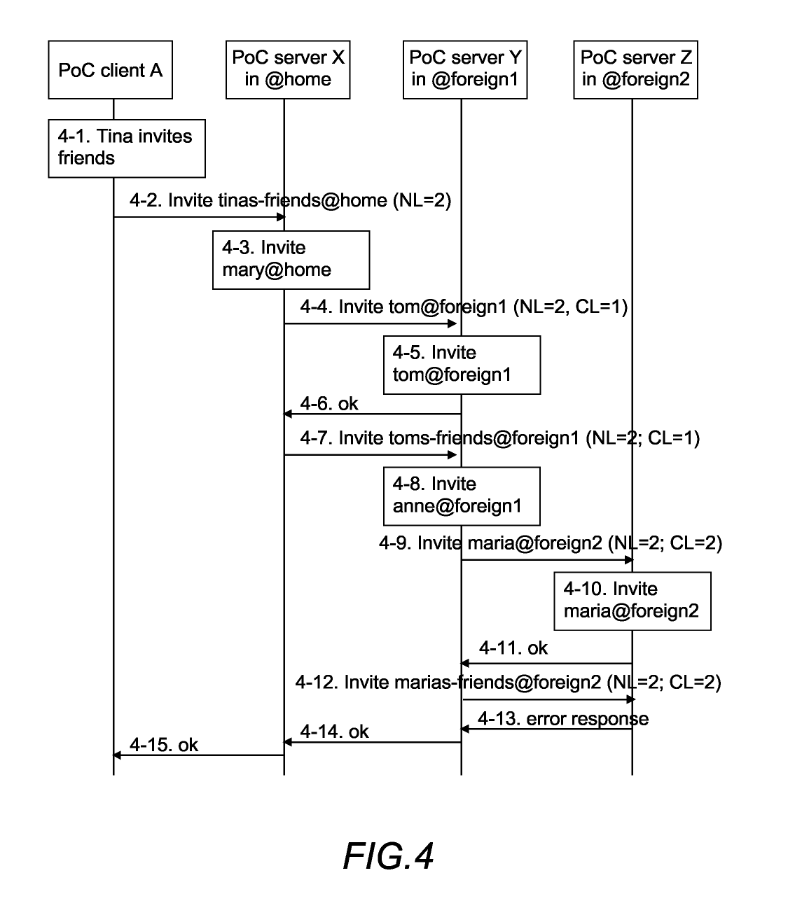

The sub-controlling PoC function has in the first embodiment a controlling level which indicates how many sub-controlling PoC functions exist between the sub-controlling function in question and the controlling PoC function. Assuming that the controlling PoC function 2-11 has a controlling level whose value is 1, the sub-controlling PoC function 2-12 has a controlling level 2 and the sub-controlling PoC function 2-13 has a controlling level 3 in the example shown in FIG. 2. (The determination of controlling levels is described in more detail with FIGS. 3 and 4.) The sub-controlling PoC function may receive talk burst reservation requests from the identities it hosts and/or from other sub-controlling PoC function(s) with a controlling level that is next above (i.e. 4 if the controlling level is 3) compared to its own controlling level, passes talk burst reservation requests from the identities it hosts or from the sub-controlling PoC function(s) with controlling level next higher compared to its own controlling level, and passes talk burst grants from the PoC function(s) with a controlling level next below (i.e. 2 if the controlling level is 3) to the identities it hosts or to other sub-controlling PoC function(s) with a controlling level next above.

In another embodiment of the invention, the sub-controlling function may exist only for identities the sub-controlling function hosts in certain sessions. In a further embodiment of the invention, the sub-controlling function may also be configured to be a sub-controlling server for other sub-controlling functions downstream, i.e. for sub-controlling functions with higher controlling levels. For example, the sub-controlling PoC function 2-12 may act as a sub-controlling function for the sub-controlling PoC function 2-13 but may not send anything to PoC function 2-11 in certain sessions. This feature may be used when there are two kinds of talk bursts, for example. The first type of talk bursts may be local within the sub-controlling server, thus not being passed upstream but passed downstream and to hosted identities, whereas the second type of talk bursts may be general, i.e. also passed upstream.

The controlling level may be used, for example, when there are competing talk burst reservation attempts (more than one users push the button to get the right to send a talk burst) so that the right to send a talk burst may be given according to the controlling level: the higher the level, the lower the priority. Alternatively, all users may have the same priority regardless of the controlling level associated to the (sub-)controlling PoC function that sent the invitation to the individual identity in question.

The participating PoC function 2-2 provides PoC session handling and policy enforcement for incoming PoC group sessions (e.g. access control, availability status) and may provide the media relay function between the PoC client function 2-3 and the controlling PoC function 2-11, the floor control message relay function between the PoC client function 2-3 and the controlling PoC function 2-11, the media relay function between the PoC client function 2-3 and the sub-controlling PoC function 2-12, 2-13 and the floor control message relay function between the PoC client function 2-3 and the sub-controlling PoC function 2-12, 2-13.

FIG. 3 is a flow chart illustrating a functionality of a PoC server according to the first embodiment of the invention. In the first embodiment, the controlling levels described above are used and as is a limit value for nested groups, NL, to limit the depth of the cascade (i.e. the depth of the nested groups). A further advantage of using the limit value for nested groups is that an endless cascade caused by a group definition containing another group definition containing yet another group definition, etc., can be avoided. The limit value for nested groups may be defined by the user in the configuration of the group identity (e.g. with a parameter associated to the group identity) and/or by the sender of the initial request (e.g. by inserting the limit into the initial request) and/or by the sender's PoC server (e.g. by inserting the limit into the initial request) and/or by any of the receiving PoC servers and/or by the network at the creation of the group identity, for example. Thus, each group may have an associated NL in its definitions that may be a default value used for groups or a user-defined value. NL may also be defined PoC function-specifically, network-specifically, such as a network wide PoC specific system default value, or PoC server-specifically. If no value for NL is given or defined, the empty value may be interpreted to be infinite or 1 or anything there between depending on configurations.

FIG. 3 starts from step 301 in which a PoC server receives a group communication invitation, later invitation. For clarity's sake, it is assumed that the target identity in the received invitation is for a target identity hosted by the PoC server. In response to the invitation, it is checked, in step 302, whether or not the session already has a controlling PoC function. This can be checked, for example, on the basis of the value of the existing “Control role taken” parameter. An example of such a parameter is “isfocus” feature parameter/feature tag. If the controlling PoC function already exists (step 302), it is checked, in step 303, whether the target identity of the invitation is a group hosted by the PoC server. If not, the target identity is invited in step 304. In other words, the invitation is forwarded either to an individual identity hosted by the PoC server or to a target network where the invitation is routed to a PoC server that hosts the identity (which may be a group identity or an individual identity).

If the target identity is a group hosted by the PoC server (step 303), the limit value for the nested groups, NL, is found out in step 305 and the controlling level value, CL, in step 306. The controlling level value is found out from an indication in the invitation request. The indication may indicate the controlling level of the sender together with the existing “Control role taken” parameter with an additional number to indicate the level, for example. The “controlling level indication” in the invitation reveals the cascade level. The PoC server hosting the initial PoC group, i.e. the controlling PoC server performing the controlling PoC function, adopts in this embodiment the controlling level 1 and sends invitations to the “not hosted” members of the initial group with “controlling level indication” set to 1. The “Control role taken” parameter may also be used to indicate the controlling level. For example, the value of the “Control role taken” parameter may be updated each time a sub-controlling function is triggered.

When NL and CL are known, their values are compared in step 307. If CL is smaller than NL, CL is updated, in step 308, by adding 1 to it, and the PoC server starts to perform, in step 309, the sub-controlling PoC function with the updated controlling level and sends, in step 310, an invitation with the updated CL to each target identity on the group member list. In other words, each invitation is forwarded either to an individual identity hosted by the PoC server or to a target network where the invitation is routed to a PoC server that hosts the identity (which may be a group identity or an individual identity).

If CL is not smaller than NL (step 307), the invitation is rejected, in step 311, by sending an error response.

If the session does not have a controlling PoC function (step 302), it is checked, in step 312, whether the PoC server fulfils the condition relating to be the PoC server performing the controlling PoC function. The conditions are stated above with FIG. 2. If the condition is fulfilled, the PoC server starts, in step 313, to perform the controlling PoC function, and sends, in step 314, an invitation to each member on the group member list, the invitations to non-hosted members having a “Control role taken” parameter with an additional number to indicate that the controlling level is 1. If the condition is not fulfilled (step 312), the invitation is forwarded, in step 315, towards the target network.

Although not explicitly stated above, the invitations according to the first embodiment preferably contain NL if the original invitation contained it. However, it is possible to send invitations without NL, even in situations where the original invitation contained NL, and vice versa. Further, it is possible to define a default NL for a PoC server (one or more, even each PoC server may have its own default NL). Depending on the configurations, the PoC server-specific default NL may be overridden by, or it may override, NL received in the invitation or NL defined for the group, NL defined for the PoC function or NL defined for the network in question.

In another embodiment, it may be checked in step 307 whether CL is smaller or equal to NL or whether the difference between them reaches or exceeds a predetermined level.

It is also possible that optimal routing is used, for example as follows: a sub-controlling PoC server may drop itself from the “controlling” path, i.e. skip steps 308 and 309, in some special cases. An example of such a special case is that there is only one member in the group in question. If there is only one member, there is actually no group to control and, therefore, the PoC server in question can drop the sub-controlling PoC function since the participating PoC function takes care of the required functionality. If the sub-controlling PoC function and the participating PoC function are not in the same PoC server, the sub-controlling PoC server may drop itself from the path.

FIG. 4 is a signaling diagram illustrating signaling according to the first embodiment of the invention. In FIG. 4, only relevant network elements (functions) for illustrating the invention are shown and only part of the actual signaling. Furthermore, for clarity's sake, it is assumed that there is only one PoC server (i.e. PoC functionality) in one network although one network may contain more than one PoC server hosting different groups within one network. In the example used with FIG. 4, Tina has defined in her home PoC network a group, tinas-friends@home, which comprises the following members: mary@home, tom@foreign1, and toms-friends@foreign1. The last one is a group defined by Tom to comprise the following members: anne@foreign1, maria@foreign2, and marias-friends@foreign2. Again, the last one is a group comprising the following members: jack@foreign2, harry@foreign3, and harrys-friends@foreign3. In these examples, the names are selected, for clarity's sake, so that they reveal whether or not the identity is an individual identity or a group identity. However, a PoC server cannot deduce that information on the basis of the group names. Although, for example, a domain foreign1 may have a PoC server Y1 hosting a target identity tom@foreign1 and a PoC server Y2 hosting a target identity toms-friends@foreign1, in the below it is, for clarity's sake, assumed that only one PoC server, i.e. Y, is hosting all target identities in the domain foreign1.

Referring to FIG. 4, Tina uses the PoC client A and invites, in point 4-1, her friends to a PoC group session. The PoC client A sends invite message 4-2. In this example, it is assumed that the one who invites sets the limit value for the nested groups, i.e. NL. Because Tina does not want to invite Tom's groups, only the individual members, she (and/or her user equipment) has given the value 2 for NL, and it is added to message 4-2. A PoC server X in the domain home and hosting the group, receives message 4-2 and becomes a controlling PoC server with controlling level value 1. The PoC server X then starts to send invitations to the group members by inviting, in point 4-3, mary@home. In more detail, point 4-3 contains the following: PoC server X as a controlling PoC server of the PoC group “tinas-friends@home” sends an invitation to the participating PoC server that is Mary's home PoC server and this sends the invitation to Mary's PoC client. However, for the sake of clarity, these steps are not illustrated in FIG. 4. In the case of a situation in which Mary's home PoC server is the PoC server X, the invitation may be handled internally in PoC server X and then sent to Mary's PoC client from PoC server X instead of sending the invitation from the controlling PoC server X to the participating PoC server X.

The next member, tom@foreign1, is invited by sending message 4-4 having NL value 2 and CL value 1 to a PoC server Y in the domain foreign1. Because the target identity, i.e. tom@foreign1, is not a group hosted by the PoC server Y, the PoC server Y invites, in point 4-5, the target identity (without becoming a sub-controlling PoC server) and sends an acknowledgement in message 4-6. Then, the PoC server X invites the last member, toms-friends@foreign1, by sending message 4-7 having NL value 2 and CL value 1 to the PoC server Y in the domain foreign1.

Because the target identity is a group hosted by the PoC server Y and CL is smaller than NL, the PoC server Y becomes a sub-controlling PoC server with controlling level 2 and starts to send invitations to the members of the hosted group by inviting, in point 4-8, anne@foreign1 in the same way as disclosed above with point 4-3. Then maria@foreign2 is invited by sending message 4-9 with NL value 2 and CL value 2 to a PoC server Z in the domain foreign2. Because the target identity is not a group hosted by the PoC server Z, the PoC server Z invites, in point 4-10, the target identity maria@foreign2 (without becoming a sub-controlling PoC server) and sends an acknowledgement in message 4-11. Then, the PoC server Y invites the last member, marias-friends@foreign2, by sending message 4-12 having NL value 2 and CL value 2 to the PoC server Z in the domain foreign2. Because the target identity is a group hosted by the PoC server Z, but the CL is not smaller than NL, the group identity is not expanded. Thus Jack, Harry, and Harry's friends are not invited but instead an error message 4-13 is sent to the PoC server Y which then sends acknowledgement message 4-14 to the PoC server X which in turn sends acknowledgement message 4-15 to the PoC client A.

FIG. 5 is a signaling diagram illustrating another implementation according to the first embodiment of the invention. The example used with FIG. 5 is the same as with FIG. 4 with the same assumptions. In this example, a default value for NL is used, the value being 2. Examples of default values are given above. Since a default value is used, no NL value is transmitted in the messages. Another difference is that in the implementation illustrated in FIG. 5, the controlling PoC server sends invite messages without a CL value to other PoC servers, whereas the sub-controlling PoC servers send invitation messages with the CL value and optionally also with the NL value. In other words, in this exemplary implementation, a PoC server is configured to recognize that a controlling PoC server exists in response to receiving an invite message from another PoC server, to use the CL indicated by the invite message when comparing it with the default NL, and to send further invite messages with an updated CL value. The PoC server is configured to deduce, based on an invite message without a CL value and received from another PoC server, that the CL value used in comparison is 1.

Referring to FIG. 5, Tina uses the PoC client A and invites, in point 5-1, her friends to a PoC group session. The PoC client A sends invite message 5-2. A PoC server X in the domain home and hosting the group receives message 5-2, notices that the message was not sent by another PoC server, and becomes a controlling PoC server with controlling level value 1. The PoC server X then starts to send invitations to the group members by inviting, in point 5-3, mary@home in the same way as disclosed above with point 4-3. The next member, tom@foreign1, is invited by sending message 5-4 to PoC server Y in the domain foreign1. Because the target identity, i.e. tom@foreign1, is not a group hosted by the PoC server Y, the PoC server Y invites, in point 5-5, the target identity (without becoming a sub-controlling PoC server) and sends an acknowledgement in message 5-6. Then, the PoC server X invites the last member, toms-friends@foreign1, by sending message 5-7 to the PoC server Y in the domain foreign1. Since the PoC server X is the controlling PoC server, the invite messages do not contain a CL value.

Because the target identity is a group hosted by the PoC server Y and, in this example, because the invitation was received from another PoC server without the CL value, the PoC server Y assumes, in this example, that CL is 1 and that a controlling PoC server exists. Because CL is smaller than NL, the PoC server Y becomes a sub-controlling PoC server with controlling level 2 and starts to send invitations to the members of the hosted group by inviting, in point 5-8, anne@foreign1 in the same way as disclosed above with point 4-3. Then maria@foreign2 is invited by sending message 5-9 with CL value 2 to PoC server Z in the domain foreign2. Because the target identity is not a group hosted by the PoC server Z, the PoC server Z invites, in point 5-10, the target identity maria@foreign2 (without becoming a sub-controlling PoC server) and sends an acknowledgement in message 5-11. Then, the PoC server Y invites the last member, marias-friends@foreign2, by sending message 5-12 having CL value 2 to the PoC server Z in the domain foreign2. Because the target identity is a group hosted by the PoC server Z, but CL is not smaller than NL, the group identity is not expanded. Thus Jack, Harry, and Harry's friends are not invited but instead an error message 5-13 is sent to the PoC server Y, which then sends acknowledgement message 5-14 to the PoC server X, which in turn sends acknowledgement message 5-15 to the PoC client A.

If the nested limit default value NL had been 1 in the above-described example illustrated in FIG. 5, instead of becoming a sub-controlling function and starting to invite, when receiving an invitation in point 5-7 targeted to toms-friends@foreign 1, the PoC server Y would have sent an error response to the PoC server X, because the target identity is a group hosted by the PoC server Y, but CL is not smaller than NL. Therefore, the group identity would not have been expanded. Thus, Anne, Maria, and Maria's friends (Jack, Harry, and Harry's friends) would not have been invited but instead an error message would have been sent to the PoC server X, which in turn would have sent an acknowledgement message to the PoC client A.

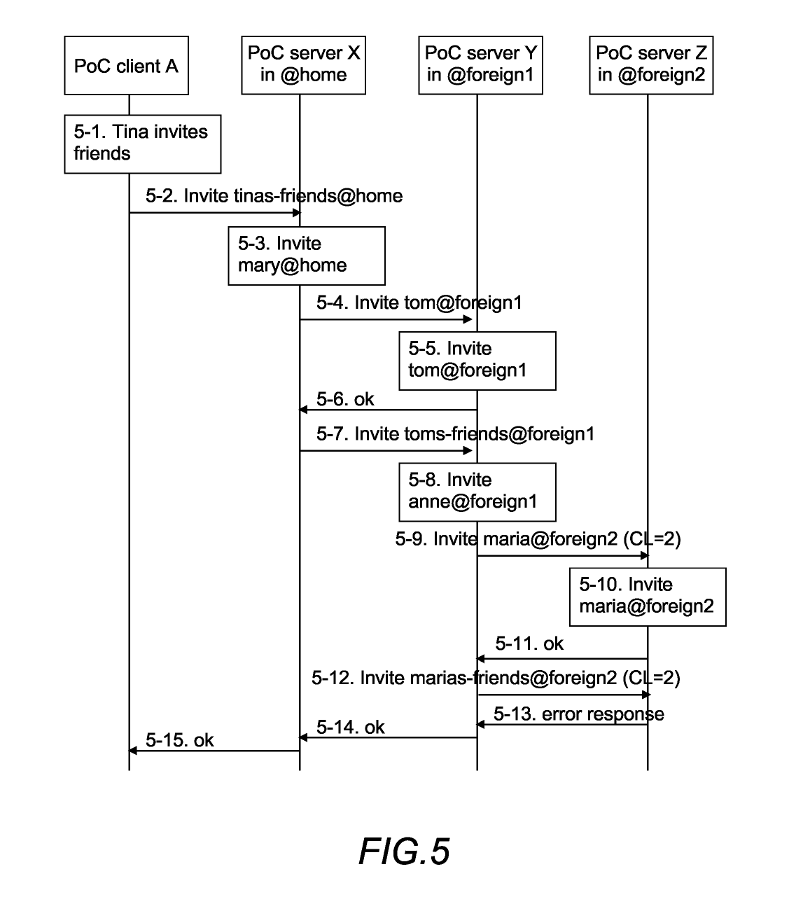

FIG. 6 is a flow chart illustrating a functionality of a PoC server according to a second embodiment of the invention in which, instead of directly inviting the members of the hosted group by the PoC server hosting the group, a list of members is gathered to the PoC server hosting the group. In the second embodiment, no sub-controlling PoC function exists and, thus, the second embodiment can be seen as a centralized solution. However, in the second embodiment, the controlling levels are used for limiting the depth of the cascade with the limit value for nested groups. The controlling levels may also be used for other purposes described above with FIG. 2. Instead of the term controlling level, the term cascade level could be used as well with second embodiment.

FIG. 6 starts from step 601 in which a PoC server receives a group communication invitation, later invitation. For clarity's sake, it is assumed that the target identity in the received invitation is for a target identity hosted by the PoC server. In response to the invitation, it is checked, in step 602, whether or not the session already has a controlling PoC function. This can be checked, for example, on the basis of the value of the existing “Control role taken” parameter. If the controlling PoC function already exists, it is checked, in step 603, whether the invitation contains an indication that instead of directly inviting the target identity, the individual identity (or identities) relating to the target identity is (are) sent back to the inviting PoC server. In other words, it is checked, whether the invitation contains a return list indication RL.

The invitation with RL may be implemented with INVITE and OPTIONS requests, for example. Thus, the invitation with RL can actually be a query to collect the invite list.

If the invitation contains RL (step 603), it is checked, in step 604, whether or not the target identity of the invitation is a group hosted by the PoC server. If not, the target identity is an individual identity which is inserted, in step 605, into the invite list which is then returned, in step 606, to the inviting PoC server. In other words, the invite list is sent back and the inviting PoC server knows that the invite list contains only individual identities. The invite list may be returned with 3xx, 2xx or 1xx responses, for example.

If the target identity is a group hosted by the PoC server (step 604), the limit value for the nested groups, NL, is found out in step 607 and the controlling level value CL in step 608. The controlling level value, revealing the cascade level, is found out from an indication in the invitation request as described above. The PoC server hosting the initial PoC group, i.e. the controlling PoC server performing the controlling PoC function, adopts in this embodiment, too, the controlling level 1 and sends invitations to the “not hosted” members of the initial group with “controlling level indication” set to 1.

When NL and CL are known, their values are compared in step 609. If CL is smaller than NL, CL is updated, in step 610, by adding 1 to it and then, in step 611, an invitation with RL and the updated CL value is sent to each not-hosted target identity on the hosted group member list. In other words, each invitation is forwarded to a target network where the invitation is routed to a PoC server that hosts the identity (which may be a group identity or an individual identity). After sending the invitations, the PoC server receives, as invitation responses, in step 612, invite lists and appends, in step 613, to its own invite list the received invite lists and individual identities of the group members the PoC server is hosting. (The PoC server's own invite list with hosted individual identities may be formed earlier). When responses to all invitations have been received, the PoC server returns, in step 606, the thus formed combined invite list to the inviting PoC server.

If CL is not smaller than NL (step 609), an empty invite list is sent, in step 614, as a response to the invitation.

If the invitation does not have RL (step 603), it is checked, in step 615, whether the target identity of the invitation is a group hosted by the PoC server. If not, the target identity is an individual identity which is invited in step 616.

If the target identity is a group hosted by the PoC server (step 615), the limit value for the nested groups, NL, is found out in step 617 and the controlling level value CL in step 618. When NL and CL are known, their values are compared in step 619. If the value of CL is smaller than the value of NL, CL is updated, in step 620, by adding 1 to it. Then, the PoC server sends, in step 621, an invitation with the updated CL value to each hosted individual target identity on the hosted group member list. The PoC server also sends, in step 621, an invitation with RL and the updated CL to each not hosted target identity on the hosted group member list, corresponding to step 611. After sending the invitations with RL, the PoC server receives, as invitation responses, in step 622, invite lists and invites, in step 623, each individual target identity on the received invite lists.

If CL is not smaller than NL (step 619), the invitation is rejected, in step 624, by sending an error response.

If the session does not have a controlling PoC function (step 602), it is checked, in step 625, whether the PoC server fulfils the condition relating to the PoC server performing the controlling PoC function. The conditions are stated above with FIG. 2. If the condition is fulfilled, the PoC server starts, in step 626, to perform the controlling PoC function, and sends, in step 627, an invitation to each member on the group member list, the invitations to non-hosted members having “Control role taken” parameter with the additional number to indicate that the controlling level is 1. If the condition is not fulfilled (step 625), the invitation is forwarded, in step 628, towards the target network.

As can be seen from the above, an advantage of the first embodiment is that each PoC group session is hosted by the very same PoC server that owns/hosts the PoC group. This enables addition of a user to, or deletion of a user from, a PoC session hosted by a sub-controlling PoC server, because the authorization may be performed on the very same server that has access to authorization data and normally performs the authorization.

In the second embodiment, as in the first embodiment, the invitations may or may not contain NL and/or CL. All other details relating to NL and CL, described above, are also valid with the second embodiment. A return list indication RL may also be left out but then the invitations preferably contain NL or CL, or another parameter, on the basis of which a PoC server recognizes that an invite list is requested.

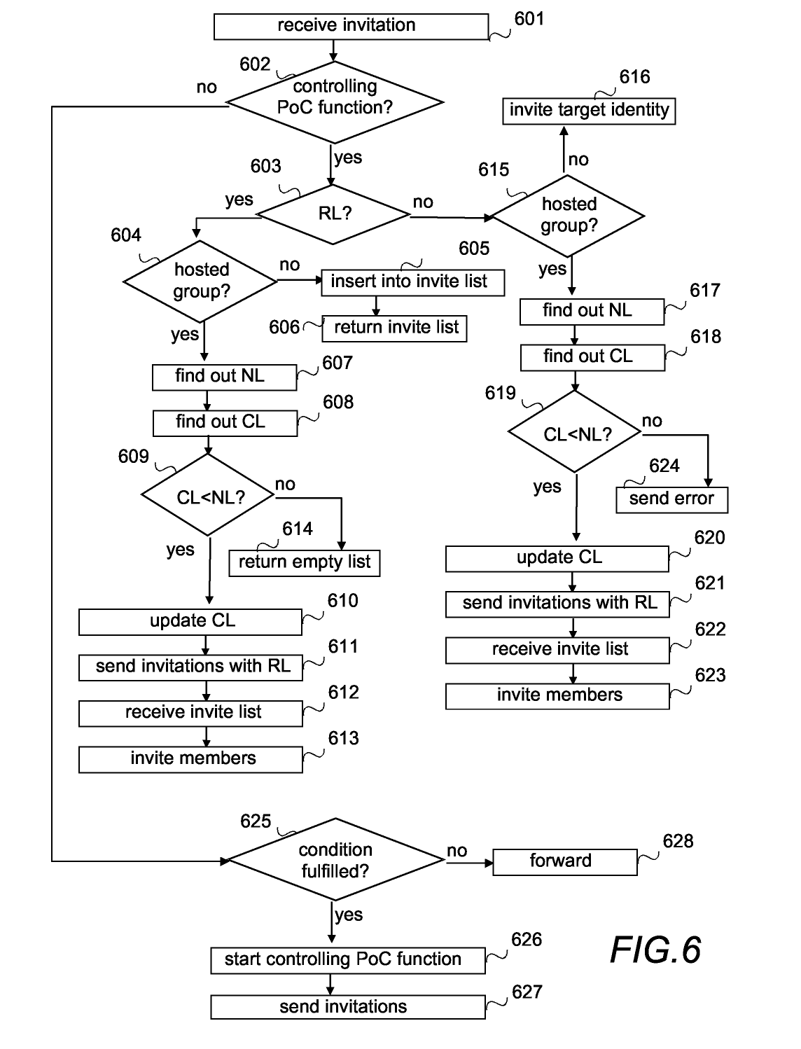

FIG. 7 is a signaling diagram illustrating signaling according to the second embodiment of the invention. The example used with FIG. 7 is the same as with FIG. 4 with the same assumptions.

Referring to FIG. 7, Tina uses the PoC client A and invites, in point 7-1, her friends to a PoC group session. The PoC client A sends invite message 7-2. In this example, it is assumed that the one who invites sets the limit value for the nested groups, i.e. NL. Tina has given the value 2 for NL, which is added to message 7-2. A PoC server X in the domain home and hosting the group receives message 7-2 and becomes a controlling PoC server with controlling level value 1. The PoC server X starts then to send invitations to the group members by inviting, in point 7-3, mary@home in the same way as disclosed above with point 4-3. The next member, tom@foreign1, is invited by sending message 7-4 having NL value 2, CL value 1 and RL value “yes” to a PoC server Y in the domain foreign1. Because message 7-4 contains return list indication RL and the target identity, i.e. tom@foreign1, is not a group hosted by the PoC server Y, the PoC server Y inserts, in point 7-5, the target identity into an invite list and sends the invite list in message 7-6. In the step 7-6a the PoC server X invites tom@foreign1 without using NL, CL and RL. In other words, the invite message is like message 7-4 but there is no NL, CL and RL. Then, the PoC server X invites the last member, toms-friends@foreign1, by sending message 7-7 having NL value 2, CL value 1 and RL value “yes” to the PoC server Y in the domain foreign1.

Alternatively the PoC server Y may invite, in point 7-5, the target identity (tom@foreign1) and send an acknowledgement in message 7-6 depending on implementation and values of CL, NL and RL (e.g. when CL=1). Then PoC server X needs not to send any message in step 7-6a.

Because the target identity is a group hosted by the PoC server Y and the CL value is smaller than the NL value, the PoC server Y gathers an invite list with controlling level 2 by inserting into the invite list, in point 7-8, anne@foreign1. Then, the PoC server Y invites the second member, maria@foreign2 by sending message 7-9 with NL value 2, CL value 2, and a return list indication RL to a PoC server Z in the domain foreign2. Because message 7-9 contained RL and the target identity is not a group hosted by the PoC server Z but an individual identity, the PoC server Z inserts, in point 7-10, into the invite list the target identity maria@foreign2 and sends the invite list to the PoC server Y in message 7-11.

Next, the PoC server Y invites the last member, marias-friends@foreign2, by sending message 7-12 having NL value 2, CL value 2, and a return list RL indication to the PoC server Z in the domain foreign2. Because the target identity is a group hosted by the PoC server Z, but the CL value is not smaller than the NL value, the group identity is not expanded. Thus, Jack, Harry, and Harry's friends are not invited but instead an empty invite list is sent in message 7-13 to the PoC server Y which then appends to its invite list, in point 7-14, the received invite lists and sends the thus formed combined invite list in message 7-15 to the PoC server X. In response to receiving the list, the PoC server X invites, in point 7-16, the target identities without NL, CL and RL. After receiving responses to the invitations, the PoC server sends acknowledgement message 7-17 to the PoC client A.

Alternatively, as discussed above with point 7-5, the PoC server Y may invite, in point 7-8, the target identity (anne@foreign1) and send an acknowledgement in a new message depending on implementation and values of CL, NL and RL (e.g. when CL=1). Then the PoC server X may invite anne@foreign1 in step 7-16 or earlier.

Although not explicitly described herein, it is obvious to one skilled in the art that the implementation principles illustrated with FIG. 5 above, may also be applied to the second embodiment of the invention.

As can be seen from the above, an advantage of the second embodiment is that floor control is simple because the controlling PoC server, i.e. the first PoC server, which takes care of the floor control, also invites all users. In order to add a user to, or delete a user from, a PoC session, an interface between GLMS (containing the authorization data) and the controlling PoC server is required since normally only the PoC server owning a PoC group has access to authorization data of the group.

In a third embodiment of the invention, the PoC servers are arranged to recognize whether or not they support the sub-controlling PoC function in response to receiving an invitation targeted to a hosted group in a situation where a controlling PoC function already exists. If they support it, they act according to the first embodiment. If they do not support it, they act according to the second embodiment. If a PoC server acts according to the second embodiment, all the following PoC servers downstream in the cascade (i.e. PoC servers with a “Controlling level” greater than that of the current PoC server and which will receive the request sent from this PoC server) also have to act according to the second embodiment even if they support the sub-controlling PoC function. Therefore, the invitations sent by the first PoC server acting according to second embodiment and further invitations contain an indication telling that, instead of inviting the members of the group, the hosting PoC server shall return the list of members of the group. The indication of the “second embodiment” feature (i.e. asking the list of members instead of inviting them directly) may be implemented in the SIP protocol with the OPTIONS method, after which the member list will be returned in 1xx, 2xx or 3xx response messages, such as 200 OK or 300 Multiple Choices, for example.

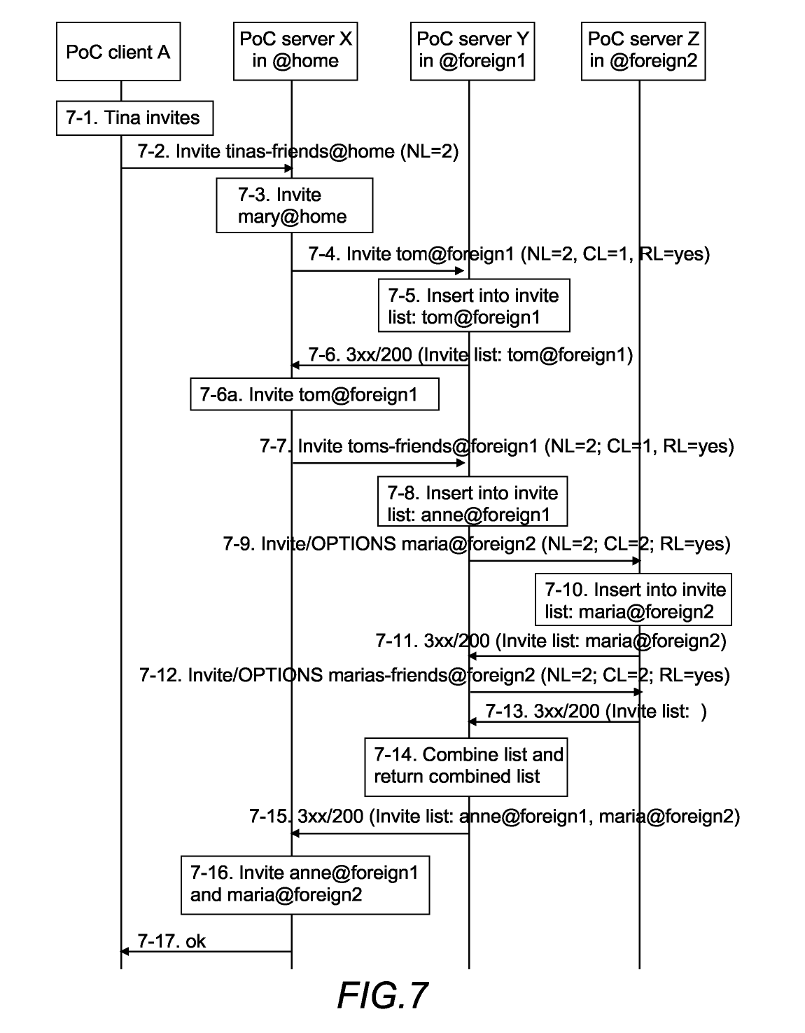

The basic principle of the third embodiment is illustrated in FIG. 8. FIG. 8 starts when, in step 801, an invitation is received, the invitation indicating that the session has a controlling PoC function. Then the PoC server checks, in step 802, whether the invitation has an indication of the “second embodiment”, such as a request list RL. If it has, the PoC server acts, in step 803, according to the second embodiment. If the invitation does not have the indication of the “second embodiment” (step 802), it is checked, in step 804, whether or not the PoC server is capable of utilizing the sub-controlling PoC function. The PoC server may not be capable of utilizing the sub-controlling PoC function because the sub-controlling PoC function is not supported by the PoC server, or the available capacity in the PoC server does not allow the usage, for example. If the sub-controlling PoC function can be used (step 804), the PoC server acts, in step 805, according to the first embodiment. If the sub-controlling PoC function cannot be used (step 804), the PoC server acts, in step 803, according to the second embodiment. Naturally, if the invitation is for an individual identity hosted by the PoC server, checking whether or not the sub-controlling PoC function is supported, may be skipped.

Yet in another embodiment of the invention, a PoC server may decide to act according to the second embodiment instead of acting as a sub-controlling PoC server. The decision may be made when invitations are sent (in which case invitations contain RL=yes) or by sending an invite list as a response to a received invitation. The PoC server according to this embodiment may contain one or more criteria on the basis of which the decision can be made. A criterion may relate to a load, a capability, etc.

Yet in another embodiment of the invention, an embodiment based on the second embodiment is a default. In this embodiment, no RL is needed in invitations.

Yet in another embodiment of the invention, Invite or Invite/OPTIONS messages without RL indicate that an invite list is requested, whereas a message with an expand parameter (or a corresponding parameter) indicates that a sub-controlling PoC functionality is requested.

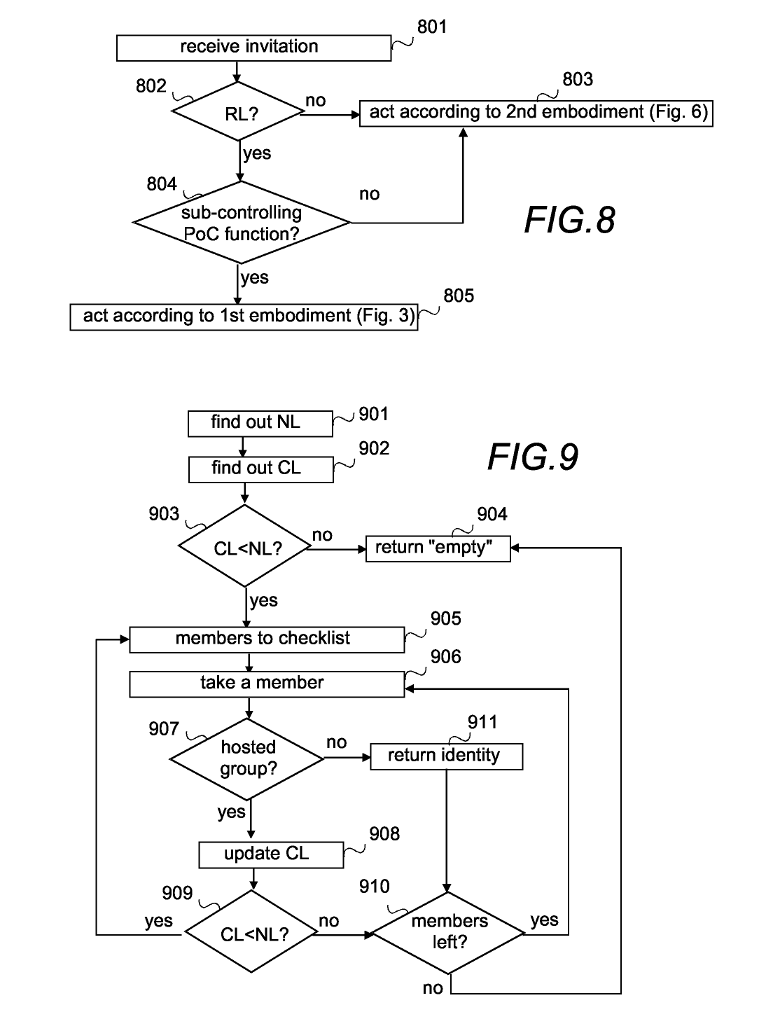

For clarity's sake it is not discussed in the above, how a PoC server according to the invention functions when the members of the hosted group contain another group hosted by the PoC server. Depending on the configuration, the PoC server may regard the hosted group in the member list as a not hosted identity, i.e. send an invitation to the group (i.e. to itself) or it may act as described below with FIG. 9, either utilizing or not utilizing CL and NL.

FIG. 9 illustrates the functionality of a PoC server according to the invention when the PoC server goes through the members of a hosted group. This functionality may be employed with the embodiments illustrated above but that is not necessary. This functionality illustrated with FIG. 9 may also be employed even when the above embodiments are not employed, for example in isolated systems or with the solution described above in section “Background of the invention”. The functionality illustrated with FIG. 9 utilizes the above-mentioned controlling levels and a limit value for nested groups, NL, to limit the depth of the cascade (i.e. the depth of the nested groups). Instead of the term controlling level, the term cascade level could be used as well. The advantage of the usage of the limit value for nested groups is described above. Furthermore, the PoC server implementing the functionality of FIG. 9 avoids sending invitations to itself. That might happen in cases where the PoC server sends invitations to each group member without checking whether the group member is a group hosted by it.

FIG. 9 starts after the PoC server has received an invitation in which the target identity is a group hosted by the PoC server and the invitation indicates that the session already has a controlling PoC function. The processing of the hosted group begins, in step 901, by finding out the limit value for the nested groups, NL, as described above. Then, in step 902, the controlling level value CL, revealing the cascade level, is found out from an indication in the invitation request as described above. Instead of the controlling level value in the invitation, or if the invitation contained no controlling level value, a preset controlling level value, such as one or zero, can be used, i.e. found out in step 902.

When NL and CL are known, their values are compared in step 903. If CL is not smaller than NL, the cascade level has been reached and “empty” is returned in step 904. By returning “empty” the functionality described with FIG. 9 indicates to the PoC server, i.e. to other functionalities in the PoC server, that all group members to be returned have been returned and the functionality described with FIG. 9 has been completed.

If CL is smaller than NL (step 903), the members of the group in question are added, in step 905, to a temporary “checklist” with a corresponding CL (or with an indication to CL) to wait to be processed. In order to go through the members, one member is taken, in step 906, from the checklist to be processed. Then it is checked, in step 907, whether or not the member's identity is a group identity hosted by the PoC server. If the identity is a hosted group identity, CL corresponding to the identity is updated, in step 908, by adding 1 to it after which the updated CL is compared, in step 909, with NL. If CL is smaller than NL, the functionality continues in step 905 by adding the members of this hosted group identity to the checklist. This time the corresponding CL is the updated CL.

If the updated CL (step 909) was not smaller than NL, the group identity is not expanded, i.e. the group members are not invited to the group communication. Instead it is checked, in step 910, whether or not the checklist is empty, i.e. whether or not there are any unprocessed group members left in the checklist. If the checklist is empty, all possible members have been processed, and “empty” is returned (step 904).

If the checklist was not empty (step 910), the functionality continues in step 906 by taking one member to be processed.

If the member is not a group identity hosted by the PoC server (step 907), the functionality returns, in step 911, the member's identity and continues in step 910 by checking whether or not the checklist is empty. The identity returned in step 911 may be an individual identity hosted by the PoC server or an identity hosted by another PoC server, which then, in turn, may be an individual identity or a group identity. (The latter only if it is allowed to form groups containing groups hosted by other PoC servers.) Preferably, the corresponding CL is returned, in step 911, with the identity, at least when the identity is not an individual identity hosted by the PoC server. This corresponding CL may then be added when the identity in question is invited to join the group.

It is obvious for one skilled in the art that when the functionality described with FIG. 9 is implemented with the above-mentioned embodiments, the overlapping steps are not performed twice.

It has been assumed in the above that there is only one PoC server per domain hosting all identities of the domain, such as PoC server Z hosting all identities of domain 2. However, it is obvious to one skilled in the art how to implement the invention when there are two or more PoC servers per domain, each hosting some identities of the domain. For example, the domain foreign2 may have a PoC server Z1 hosting the target identity maria@foreign2 and a PoC server Z2 hosting the target identity marias-friends@foreign2.

Although in the above, it is assumed that the controlling level of the controlling PoC function is 1, or the cascade level of the initial group is 1, and it is later increased, it is obvious for one skilled in the art that the invention can also be applied by setting, as the starting controlling level or cascade level, the limit value for the nested groups NL and then diminishing it step by step until it becomes zero (or reaches another given limit). It is also obvious that the controlling level or cascade level of the initial group may be negative, and it is increased until it reaches a given limit. These, as well as the comparisons disclosed above, are different examples of predefined definitions relating to the comparison of CL and NL. It is also obvious that the controlling level or the cascade level may be updated before the comparison is performed.

Although the invention is described above with embodiments utilizing the controlling levels as a cascade limit or a cascade level, it is obvious for one skilled in the art how to implement the invention without the cascade limit. For example, steps 305, 307, and 311 can be skipped in the first embodiment and the process continues as if the answer in step 307 had been “yes” and there is no need to define NL and/or send CL in the invitation messages, unless used for other purposes. Even in the case of an endless cascade, group members are still invited to join the group because, while finding out members of a group, invitations are sent to the already found out members of the previous group.

One or more of the above described parameters NL, CL and RL with values may also be a binary indication. One or more of them may be in a SIP header, in a SIP P-header, in the body of the request, in an URI-parameter, in a header parameter, in a token or the like.

The communications system may comprise PoC function(s), PoC server(s) and/or PoC client(s) with different capabilities due to that they are built according to different releases of specifications, for example. When a network element, such as a PoC server, or user equipment, such as a PoC client, is not configured to understand the above-described expansion(s), such as CL or NL, it simply ignores the expansion received in a request.

The invention has been described above assuming that the group is either a pre-arranged or pre-defined PoC group. However, an ad-hoc PoC group session may also be established and users/groups may be invited to join the ad-hoc PoC group session. In that case the PoC client may send an invitation, such as an INVITE request, targeted to a conference-factory-URI with an URI-list carried in the body of the invitation. The URI-list may look like (since the actual format to be used bears no significance to the invention, the following only illustrates the content but it is not in the actual format): ann@home.net; peter@foreign.net; anns-friends@foreign.net; peters-friends@foreign.net; susan@home.net, for example. Other examples of URI-lists can be found in the Internet Draft “draft-ietf-sipping-uri-list-conferencing-01.txt”. For example, in case of a pre-established session a REFER request carrying an URI-list in the body may be used. Examples can be found in the Internet Draft “draft-ietf-sipping-multiple-refer-00.txt”. It should be appreciated that the invitation method and the inviting requests used are not relevant to the actual invention. Therefore, ad-hoc inviting methods are not described in the Figures but simple invitations, such as “tinas-friends@home”, are used. The above-described invitations are only examples of how the PoC client may invite users/groups, and the invention is also applicable when an (initial) invitation is made in another way.

Although not explained in the above, the invention may also be applied to a general conference environment. The above-described PoC group session is actually only an example of a conference, as well as the PoC group session identity/URI is an example of a conference URI, the PoC client being an example of user equipment used to connect to a conference.

It is obvious for one skilled in the art that the invention described above may also be used with group transactions, i.e. in cases where nested groups or lists are needed without a session set-up. An example of that kind of situation is when an instant message is sent to a group having one or more groups as members. These group identities may be hosted in a group list (management) server(s) or resource list server(s) RLS, or the like, which corresponds to the PoC servers described above.

It is obvious for one skilled in the art that the invention described above may also be used with other kinds of requests. For example, the invention may be used with different kinds of message requests, such as instant messages, “store and forward” messages, and session creating messages. An example of such message requests is an instant message request sent to a group having one or more groups as members. These group identities may be hosted in a group list (management) server(s) or resource list server(s) RLS, or the like, which corresponds to the PoC servers described above. “Store and forward” messages are like instant messages but they are normally stored to make it sure that the recipient receives the message either immediately or, if he is not reachable immediately, later. Session creating messages are not bare transactions but create a session, dialog or a like. An example where session creating messages may be used is a chat session.

The steps and signaling messages shown in FIGS. 3 to 9 are not in absolute chronological order and some of the steps may be performed simultaneously or differing from the given order. Other functions can also be executed between the steps or within the steps. Some of the steps or part of the steps can also be left out. The signaling messages are only exemplary and may even comprise several separate messages for transmitting the same information. In addition, the messages can also contain other information. The messages can also be freely combined or divided into several parts. Furthermore, the names of the messages may differ from the above-mentioned ones, and the protocol may be other than SIP. Depending on the network structure, other network nodes between which different functions have been divided may participate in data transmission and signaling.

The communications system, user equipments and group communication servers implementing the functionality of the present invention comprise not only the prior-art means but also means for providing one or more of the functionalities described above. The present group communication servers comprise processors and memory that can be utilized in the functions according to the invention. All modifications and configurations required for implementing the invention may be performed as routines which may be implemented as added or updated software routines, application circuits (ASIC), and/or programmable circuits, such as EPLD (Electrically Programmable Logic Device) and FPGA (Field Programmable Gate Array).

It will be obvious to a person skilled in the art that, as the technology advances, the inventive concept can be implemented in various ways. The invention and its embodiments are not limited to the examples described above but may vary within the scope of the claims.

1. A method of inviting group members to join a group communication in a communications system providing a group communication service which allows a group member list to contain both individual identities and group identities, the method comprising:
receiving, in a first server, an invitation to a first target identity hosted by the first server;
sending, in response to the first target identity being a group identity having a group member list containing second target identities, an invitation to each second target identity not hosted by the first server, the invitation being sent to a second server hosting the second target identity.

2. A method of inviting group members to join a group communication in a communications system providing a group communication service which allows a group member list to contain both individual identities and group identities, the method comprising:
receiving, in a first server, an invitation to a first target identity hosted by the first server;
sending, in response to the first target identity being a group identity having a group member list containing second target identities, an invitation to each second target identity not hosted by the first server, the invitation requesting to provide the first server with member list of the second target identity, the invitation being sent to a second server hosting the second target identity; and
inviting, in response to receiving the member list from the second server, each member on the member list.

3. The method according to claim 1, further comprising:
comparing, in response to the target identity in the invitation being a group identity, a limit value for nested groups with a cascade value indicated in the invitation; and
sending the invitations to the second target identities only if the difference between the limit value and the cascade value is within a predefined range.

4. A method of inviting group members to join a group communication in a communications system providing a group communication service which allows a group member list to contain both individual identities and group identities, the method comprising:
receiving, in a first server, an invitation to a target identity hosted by the first server; and
sending, in response to the invitation containing an indication that a member list should be provided, a member list containing the identities covered by the target identity.

5. The method according to claim 4, further comprising:
comparing, in response to the target identity in the invitation being a group identity, a limit value for nested groups with a cascade value indicated in the invitation; and
sending the member list only if the difference between the limit value and the cascade value is within a predefined range.

6. A method in a communications system providing a group communication service which allows a group member list to contain both individual identities and group identities, the method comprising:
receiving an invitation relating to a group communication;
comparing, in response to a target identity in the invitation being a group identity, a limit value for nested groups with a cascade value; and
finding out the identities on the group member list only if the difference between the limit value and the cascade value is within a predefined range.

7. The method according to claim 6, further comprising, in response to a hosted group identity on the group member list:
updating the cascade value;
comparing the limit value for nested groups with the cascade value; and
finding out the identities on a group member list of the hosted group identity only if the difference between the limit value and the cascade value is within a predefined range.

8. A network server providing a group communication service functionality, the network server comprising a sub-controlling group communication service function.

9. The network server according to claim 8, the network server being configured, in response to receiving an invitation relating to a group communication, to check whether or not the invitation indicates that a controlling group communication service function for the group communication exists, and, in response to a controlling group communication service function existing, to compare a limit value for nested groups with a cascade value indicated by the invitation; and to become a sub-controlling group communication server by triggering the sub-controlling group service function only if the difference between the limit value and the cascade value is within a predefined range.

10. The network server according to claim 8, the network server being configured, in response to becoming a sub-controlling group communication server, to update the cascade value, to add the updated cascade value to the invitations to the group members and to send the invitations.

11. The network server according to claim 8, the network server further comprising a controlling group communication service function and being configured, in response to a controlling group communication service function not existing, to become a controlling group communication server by triggering the controlling group service function, and to invite the group members to join the group communication.

12. A network server providing a group communication service functionality which allows a group member list to contain both individual identities and group identities, the network server being configured to compare, in response to a target identity in a received invitation relating to a group being a group identity, a limit value for nested groups with a cascade value; and to find out the identities on a group member list of the group identity only if the difference between the limit value and the cascade value is within a predefined range.

13. The network server according to claim 12, the network server being configured to perform said comparison in response to receiving the invitation from another network server.

14. The network server according to claim 12, the network server being further configured to deduce the cascade value on the basis of the sender of the invitation.

15. The network server according to claim 12, the network server being further configured to use a cascade value which the invitation contained.

16. The network server according to claim 12, the network server being further configured to use a limit value for nested groups which the invitation contained.

17. The network server according to claim 12, the network server being configured to use a preset default limit value for nested groups.

18. User equipment supporting a group communication service, the user equipment being configured to add to a group communication invitation a limit value for nested groups.

19. The method according to claim 2, further comprising:
comparing, in response to the target identity in the invitation being a group identity, a limit value for nested groups with a cascade value indicated in the invitation; and
sending the invitations to the second target identities only if the difference between the limit value and the cascade value is within a predefined range.

20. The network server according to claim 9, the network server being configured, in response to becoming a sub-controlling group communication server, to update the cascade value, to add the updated cascade value to the invitations to the group members and to send the invitations.

21. The network server according to claim 9, the network server further comprising a controlling group communication service function and being configured, in response to a controlling group communication service function not existing, to become a controlling group communication server by triggering the controlling group service function, and to invite the group members to join the group communication.

22. The network server according to claim 10, the network server further comprising a controlling group communication service function and being configured, in response to a controlling group communication service function not existing, to become a controlling group communication server by triggering the controlling group service function, and to invite the group members to join the group communication.

23. The network server according to claim 13, the network server being further configured to deduce the cascade value on the basis of the sender of the invitation.

24. The network server according to claim 13, the network server being further configured to use a cascade value which the invitation contained.

25. The network server according to claim 13, the network server being further configured to use a limit value for nested groups which the invitation contained.

26. The network server according to claim 14, the network server being further configured to use a limit value for nested groups which the invitation contained.

27. The network server according to claim 13, the network server being configured to use a preset default limit value for nested groups.

28. The network server according to claim 14, the network server being configured to use a preset default limit value for nested groups.
